(19) United States
(12) Patent Application Publication
(10) Pub. No.: US 2006/0245739 A1
(43) Pub. Date: Nov. 2, 2006

(54) Electronic camera device and method of creating history file

(75) Inventors: Shiro Nagaoka, Ome-shi (JP); Tatsuhiko Ikehata, Ome-shi (JP); Kei Tashiro, Ome-shi (JP); Toyokazu Aizawa, Sagamihara-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/412,134

(22) Filed: Apr. 27, 2006

(30) Foreign Application Priority Data
Apr. 27, 2005 (JP) 2005-129579

(51) Int. Cl. H04N 5/00

(52) U.S. Cl. 386/117

(57) ABSTRACT

A camera includes a storage unit which stores an imaged image on a first recording medium as an image file, a selection unit which arbitrarily selects an image from images stored on the first recording medium, a copy unit which copies the selected image to a second recording medium, and a history file creation unit which creates a list of the copied image as a history file and stores the history file on the first recording medium.

### CROSS-REFERENCE TO RELATED APPLICATIONS

This application is based upon and claims the benefit of priority from Japanese Patent Application No. 2005-129579, filed Apr. 27, 2005, the entire contents of which are incorporated herein by reference.

### BACKGROUND

1. Field

The present invention relates to an electronic camera device having a function of backing up a plurality of images shot and recorded on a recording medium to another recording medium.

2. Description of the Related Art

An electronic camera device, such as a digital camera, can mount a portable recording medium, such as a memory card using a semiconductor memory. Shot images can be stored on the memory card. By user operation, image data stored on the memory card is read and displayed on a liquid crystal display unit mounted on the camera.

Jpn. Pat. Appln. KOKAI Publication No. 2004-242093 discloses a digital camera capable of reliably deleting only unnecessary images among a plurality of images shot by the digital camera and stored on a memory card. The camera of this document has a first and a second LCD panels. When the camera is set to an image delete mode, an image list screen showing, in list form, index images of the images stored on the memory card is displayed on the first LCD panel. At the same time, on the second LCD panel is displayed a delete image list screen showing, in list form, index images which are selected on the image list screen as targets to be deleted, and are moved from the first LCD panel. When the delete target images displayed on the second LCD panel are selected again, the delete instruction is reset and the target images are moved back to the first LCD panel from the second LCD panel. By selecting a delete execution icon, image data corresponding to the index images displayed on the second LCD panel is deleted.

Recently, a digital camera having installed thereon a hard disk drive (HDD) which is a mass recording medium has been developed. In such a camera, the number of storable still images and the moving image recording time are dramatically increased over conventional digital cameras.

Images including still and moving images that are stored in the HDD of the digital camera can be backed up, i.e., copied, to a memory card mounted on the camera or to a recording medium on a personal computer (PC) connected to the camera. When, for example, a user selectively deletes images stored in the HDD of the digital camera, to check whether the images have been backed up to another recording medium, the user needs to check on data on the memory card mounted on the camera or data on an external recording medium such as a personal computer and verify that the data is the same as data stored in the HDD of the camera.

As such, in conventional techniques, the backup state of stored images is determined by a human visual confirmation of an image and past memory, and thus, data may be deleted by mistake.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIGS. 1A and 1B are diagrams each showing an exemplary overview of an electronic camera device 1 to which the present invention is applied;

FIG. 2 is a block diagram showing an exemplary configuration of an optical system and an electrical system of the electronic camera device 1;

FIG. 3 is a diagram showing an exemplary state in which a shooting menu is displayed on a liquid crystal monitor 111 by an operation performed on a menu button 117;

FIGS. 4A to 4E are diagrams showing an exemplary state in which an item called “album selection” is selected on the liquid crystal monitor;

FIG. 5 is a diagram showing an exemplary configuration for the case in which the camera 1 is connected to either a PC 207 or a dedicated writer 200;

FIG. 6 is a flowchart showing an exemplary operation of creating a backup list;

FIG. 7 is a diagram showing an exemplary backup list creation screen;

FIGS. 8A and 8B are diagrams showing an exemplary backup list and an exemplary history file;

FIG. 9 is a diagram showing an exemplary screen asking whether image data is arranged in time-series order;

FIG. 10 is a diagram showing an exemplary screen allowing a user to select a recording medium where an image is to be saved;

FIG. 11 is a flowchart showing an exemplary process of updating a second history file created on an SD card;

FIG. 12 is a diagram showing an exemplary cable connection instruction screen;

FIG. 13 is a diagram showing an exemplary updated history file;

FIG. 14 is a flowchart showing an operation according to a second embodiment of the present invention;

FIG. 15 is an exemplary flowchart for explaining a backup status display function at image playback;

FIG. 16 is a flowchart showing another embodiment using a backup status shown by the history file; and

FIG. 17 is a diagram showing an exemplary file-name list 209 to which backup history information is appended.

### DETAILED DESCRIPTION

Various embodiments according to the invention will be described hereinafter with reference to the accompanying drawings. In general, according to one embodiment of the invention, there is provided an electronic camera device comprising: a shooting unit which shoots an optical image and provides one of a still image and a moving image; a storage unit which has a first recording medium and records the image obtained by the shooting unit on the first recording medium as an image file; a selection unit to arbitrarily select an image from images stored on the first recording medium; a copy unit which copies the image selected by the selection unit to a second recording medium; and a history file creation unit which creates a list of the image copied by the copy unit as a history file and stores the history file on the first recording medium.

In an electronic camera device according to an embodiment of the present invention, the backup state of target image data can be checked not by user review or by determination based on past memory, and thus, it is possible to prevent a misoperation such as deletion of data by mistake.

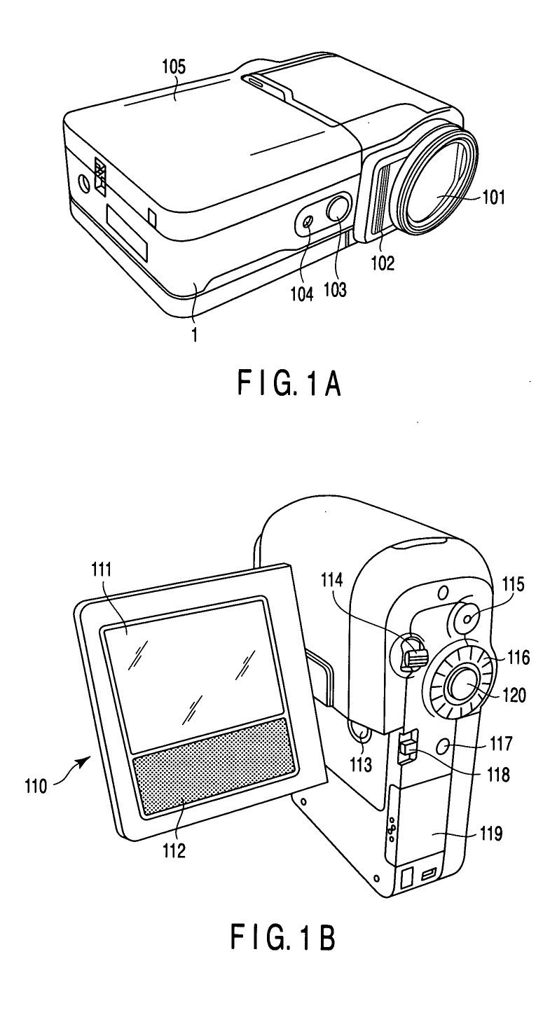

FIGS. 1A and 1B are drawings each showing an exemplary overview of an electronic camera device 1 to which the present invention is applied. FIG. 1A is a perspective view of the electronic camera device 1 as viewed from the bottom front. Reference numeral 101 denotes an imaging lens, 102 denotes a flash bulb, 103 denotes a shutter button, 104 denotes a remote control reception unit, and 105 denotes a battery cover.

FIG. 1B is a perspective view of the electronic camera device 1 as viewed from the left rear. Reference numeral 111 denotes a liquid crystal monitor and 112 denotes a speaker, which are integrated into a single unit as a display unit 110. The display unit 110 normally fits into a depression portion of a main body of the electronic camera device 1, and is opened when in use as shown in the drawing.

Reference numeral 115 denotes a movie record button on which an operation is performed when recording a moving image. 114 denotes a zoom bar which is used for zoom adjustment. 116 denotes a jog dial which is used to perform the operation of selecting various functions. A selected function is accepted by pressing an OK button 120. The operation contents and status of the jog dial 116 are displayed on the liquid crystal monitor 111. 117 denotes a menu button which is used to display a menu on the monitor 111. 118 denotes a mode lever which is used to switch between a shooting mode and a playback mode. 119 denotes a cover for a slot that accommodates a removable semiconductor memory card. 113 denotes a power button for power on/off.

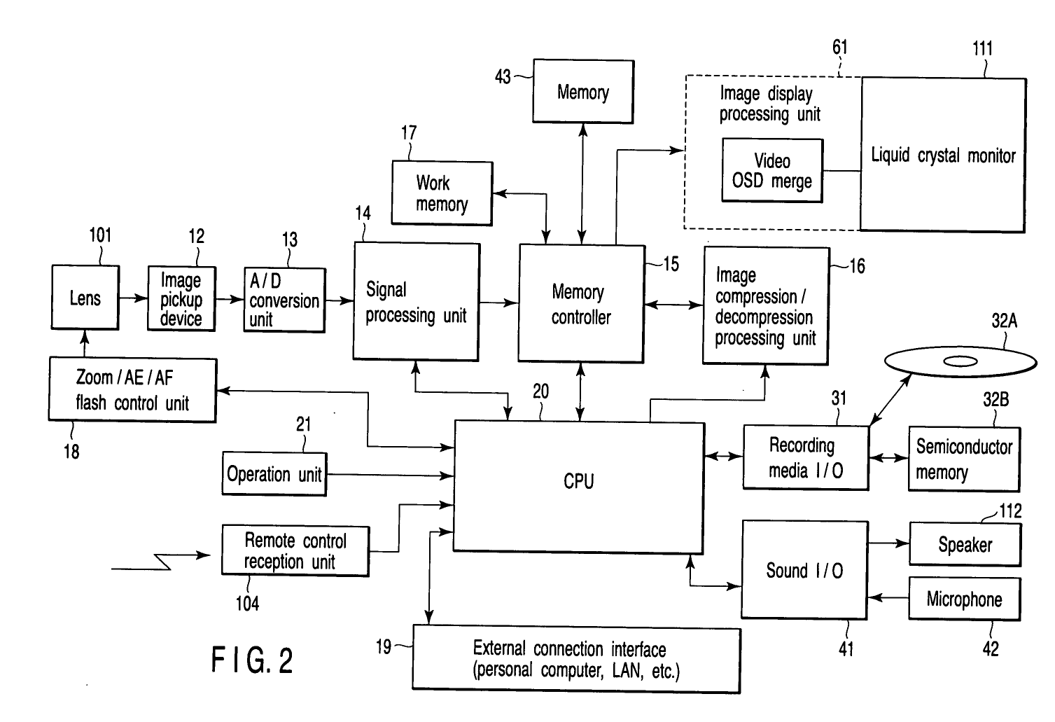

FIG. 2 is a block diagram showing an exemplary configuration of an optical system and an electrical system of the electronic camera device 1. A subject image captured by the lens 101 is imaged on an imaging surface of an image pickup device 12 (e.g., a CCD image pickup device). Here, the subject image is converted into an electrical signal and then converted into a digital signal by an analog/digital (A/D) conversion unit 13. The digital signal is then inputted to a signal processing unit 14. The signal processing unit 14 performs a gamma correction, a color signal separation, a white balance adjustment, and the like. The image pickup device 12, the A/D conversion unit 13, the signal processing unit 14, and the like function as an imaging unit.

When, in a normal shooting state, a shutter operation is not performed, video data from the signal processing unit 14 is inputted to an image display processing unit 61 through a memory controller 15. The image display processing unit 61 performs a conversion process for displaying the shot image on the liquid crystal monitor 111 and a merging process for a menu and the like. Image data from the image display processing unit 61 is supplied to the liquid crystal monitor 111. Accordingly, an image being imaged or a subject image in a standby state at which the user is aiming is displayed on the liquid crystal monitor 111.

When a shutter operation is performed, imaged image data is subjected to an image compression (e.g., a compression by a JPEG method) by an image compression/decompression processing unit 16, and then, stored on either a hard disk 32A or a semiconductor memory (e.g., a memory called an SD card) 32B through a recording media I/O 31 under control of a central processing unit (CPU) 20. The recording media is not limited to those described above and may be an optical disk.

When image data stored on the recording media is read, the image data is subjected to a decompression process by the image compression/decompression processing unit 16 under control of the CPU 20, and then, inputted to the image display processing unit 61 through the memory controller 15. Accordingly, a playback image is displayed on the liquid crystal monitor 111.

A work memory 17 is used when, for example, image data is edited, a thumbnail image is created, or the order of images is changed. Furthermore, the work memory 17 is also used when various icons are edited. The work memory 17 can store image data of a single screen or image data of a plurality of screens. Image data stored in the work memory 17 is inputted to the image display processing unit 61 through the memory controller 15 and thus the state of an image edit can be checked on the liquid crystal monitor 111.

Upon editing or shooting, control is performed by the CPU 20 and sound data can also be captured through a microphone 43 and a sound I/O 41. Sound data is paired with data of a shot image and stored on the recording media. When the stored sound data is played back, the sound data is read from the recording media together with the data of the shot image. Then, while playing back the image, the sound can be outputted from the speaker 112 through the sound I/O 41. Note that in the present invention, when an image is played back for a check, sound can be muted.

An external operation signal is provided to the CPU 20 through an operation unit 21 or the remote control reception unit 104. Upon shooting, the CPU 20 can perform, through a control unit 18, a zoom adjustment, an automatic iris adjustment (AE), an automatic focus adjustment (AF), a flash control, and the like, according to an operation signal. In addition, the CPU 20 is also connected to an external connection interface 19, allowing the camera to be connected to an external display device such as a TV. The operation unit 21 here is a collective term that refers to various operation buttons shown in FIG. 1.

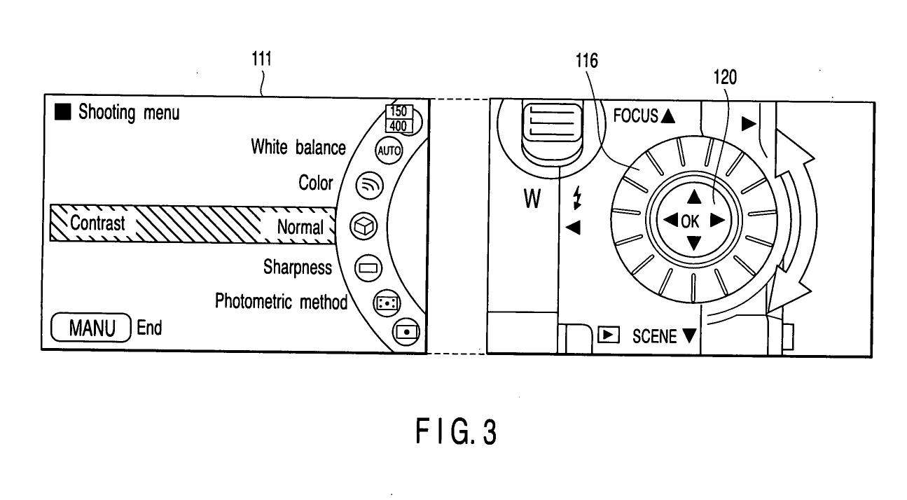

FIG. 3 is a diagram showing a state in which a shooting menu is displayed on the liquid crystal monitor 111 by an operation performed on the menu button 117. The jog dial 116 and the liquid crystal monitor 111 are disposed adjacent to each other. On the liquid crystal monitor 111 is displayed an image that looks like part of a circle of the jog dial 116. By rotating the jog dial 116, various items on the shooting menu appear on a screen one after another in a scrolling manner. An item positioned at the center of the screen in an up/down direction is being selected by a cursor.

By pressing the OK button 120 when a desired item is selected, the screen switches to another screen allowing the user to perform detailed settings for the selected item.

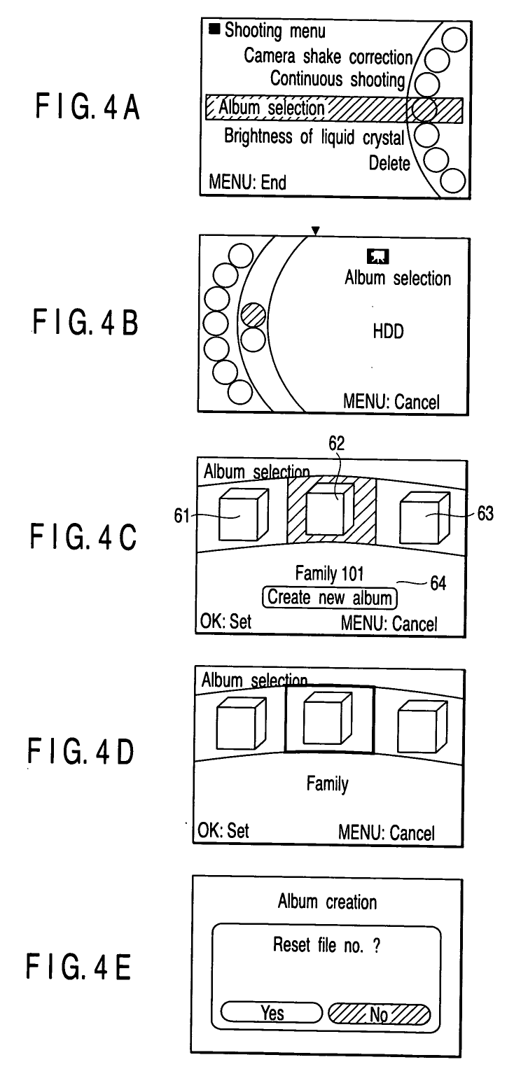

FIG. 4A is a diagram showing a state in which the item called “album selection” is selected. Here, by pressing the OK button 120, as shown in FIG. 4B, it is asked whether either a hard disk (HDD) or an SD card is selected as a recording media. Here, by pressing the OK button 120 in a direction of an upward triangle arrow or in a direction of a downward triangle arrow, the user can select either the HDD or the SD card by the cursor. As such, the OK button 120 operates not only as a normal press button but also as a joystick. When the HDD is selected by the cursor, a display indicating “HDD” is provided to the liquid crystal monitor 111. When the SD card is selected, a display indicating “SD card” is provided to the liquid crystal monitor 111. FIG. 4B is a diagram showing a state in which the “HDD” is selected.

Here, when there are already a plurality of albums on the hard disk, as shown in FIG. 4C, album icons 61, 62, and 63 appear along with a rotation operation performed on the jog dial 116. This case shows that an album represented by the album icon 62 positioned in the center is selectable. An album name 64 of this album is also displayed.

Here, by pressing the OK button 120 to select the album corresponding to the album icon 62, imaging data recorded on the recording medium is associated with the album.

FIG. 4C is a diagram showing a state in which the album called “Family 101” is selected. However, among family members, a son may want to create a second album “Family” for images shot by the son, against a first album “Family 101” created by his father.

In this case, by pressing the OK button 120 in the direction of the downward triangle arrow, the son can select the item called “create new album”. With the “create new album” being selected, by pressing the OK button 120, as shown in FIG. 4D, a new album is created. Here, the second album is set as “Family 102”, for example. Therefore, the first and second albums are distinguishable.

Subsequently, by further pressing the OK button 120, as shown in FIG. 4E, it is asked whether the number assigned to an image file to be stored in the album is reset. This is because when the second album is created in succession to the first album as a family it is preferred that the image file numbers be sequential, while when the first album is treated independently of the second album it is preferred that an image file in each album start with an initial value.

In this case as well, by pressing the OK button 120 in either the direction of the upward triangle arrow or the direction of the downward triangle arrow, the user can select either “Yes” or “No”.

In the state of FIG. 4C, by further rotating the jog dial 116, the album icons (61 to 63, for example) are scrolled. The user can select an arbitrary album or can create a new album.

Now, the creation and update of a history file according to the present invention will be described.

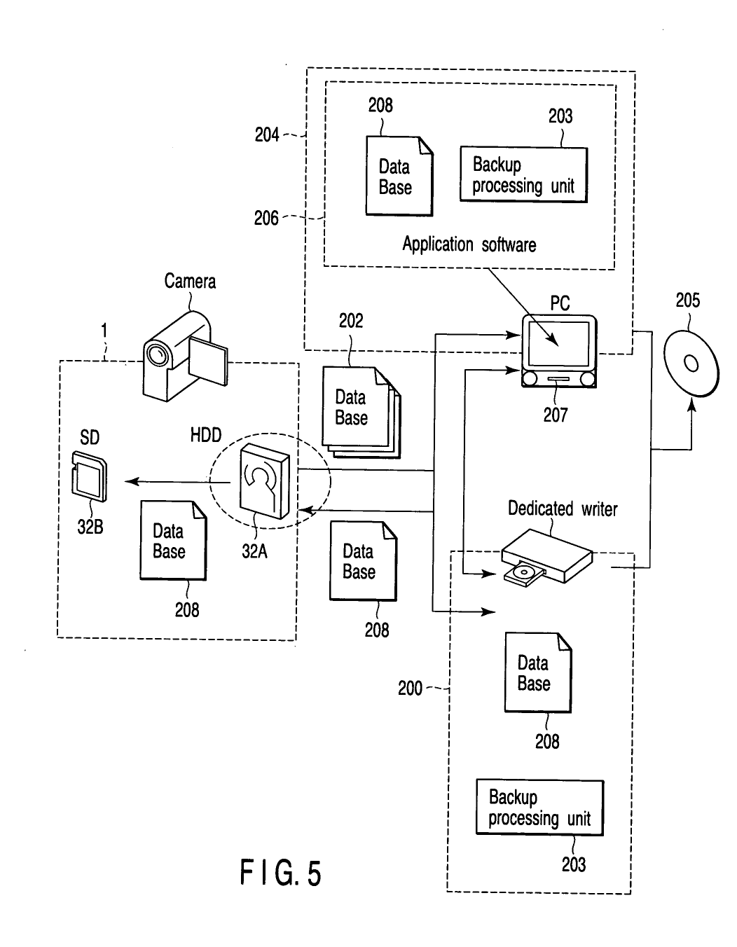

FIG. 5 is a diagram showing an exemplary configuration of a system in which the camera 1 is connected to either a PC 204 or a dedicated writer 200. The dedicated writer 200 is a device capable of recording image data on general-purpose portable media 205 such as a DVD. The PC 204 has a disk drive 207 that records/plays back image data on/from an HDD (not shown) and/or the portable recording media 205. The camera 1 can be connected to the dedicated writer 200 either with a cable, such as a USB cable, or wirelessly. Similarly, the camera 1 can be connected to the PC 204 either with a cable, such as a USB cable, or wirelessly.

Now, the operation of backing up (copying) a still or moving image shot by the camera 1 will be described.

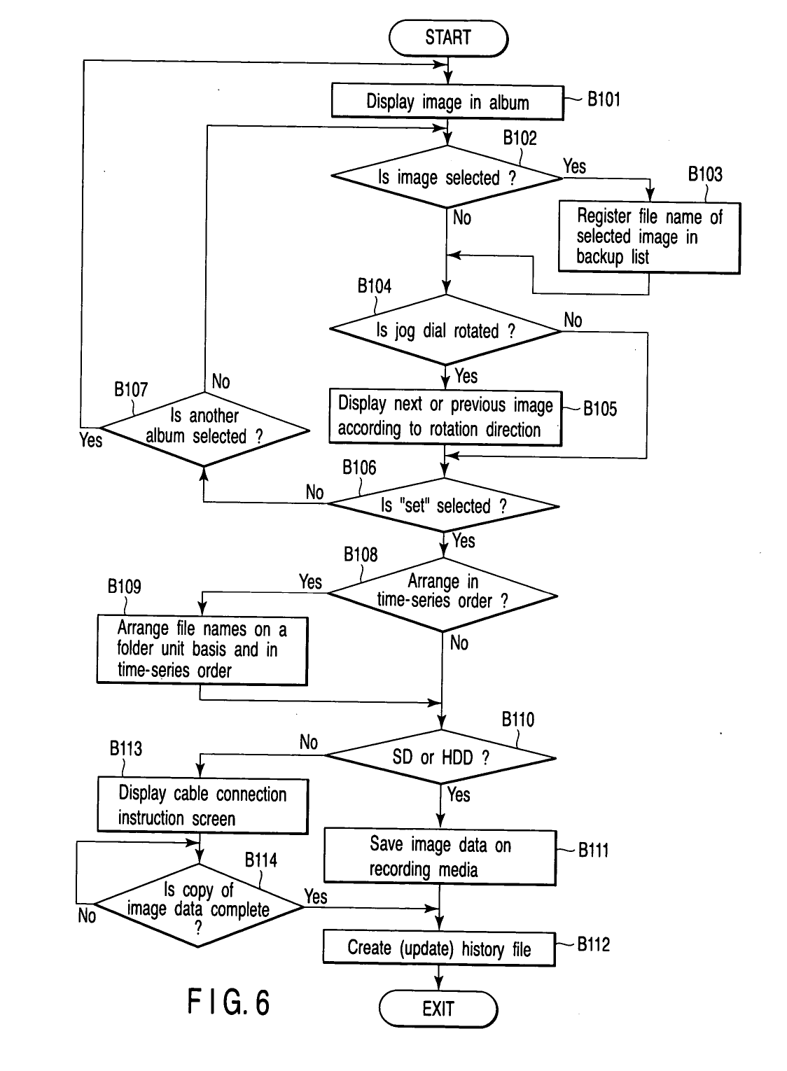

FIG. 6 is a flowchart showing an exemplary process of creating a backup list and an exemplary process of creating and updating a history file which shows a backup status according to the present invention. Here, the case of backing up images stored on the HDD 32A to another recording medium will be described. Note that the present invention is not limited to the above case; the present invention can also be applied to the case, for example, of backing up images stored on the SD card 32B to the HDD 32 or an external recording device such as the PC 204.

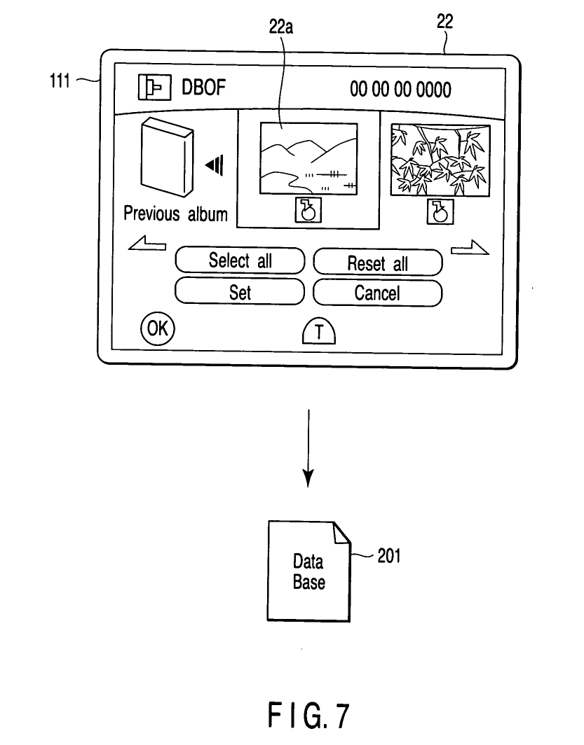

First, in response to an operation performed by the user on the operation unit 21, the CPU 20 displays a backup list creation screen 22 such as the one shown in FIG. 7 (B (Block) 101). On the screen 22 of FIG. 7 are displayed images and an album which are stored on the HDD 32A. At substantially the center of the screen 22 is displayed a selectable image 22a. When this image is selected by pressing the OK button 120 (“YES” at B102), the CPU 20 registers the file name of the selected image in a backup list 201 (B103).

When the jog dial 116 is rotated by the user (“YES” at B104), the CPU 200 scrolls, according to the rotation direction of the jog dial 116, images to be displayed on the backup list creation screen 22 in one of directions of arrows in the drawing, and displays the next or previous image on the center of the screen 22 (B105). Here, for the next image after the last image in a given album, an icon of a next album is displayed. For the previous image to the first image in a given album, an icon of a previous album is displayed. The screen 22 of FIG. 7 shows this state.

When the icon of the album is displayed on the center of the screen 22 and selected by the OK button 120 (“YES” at B107), the CPU 20 displays the first image stored in the selected album on the center of the screen 22 (B101). In this manner, the user can select images over a plurality of albums and register the selected images in the backup list 201.

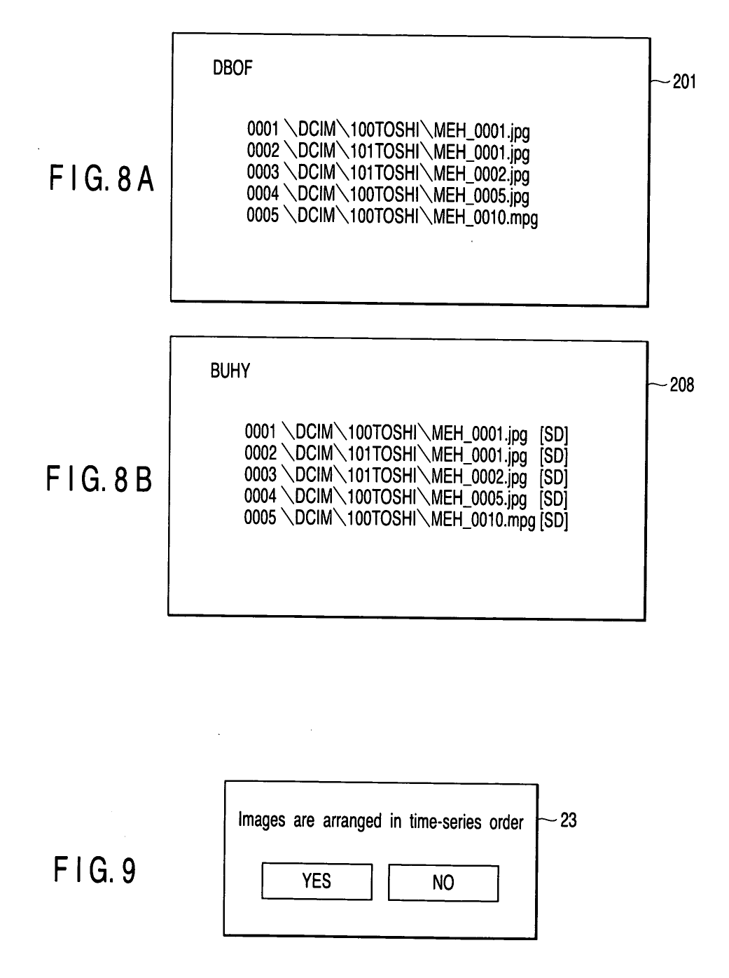

FIG. 8A is a diagram showing an exemplary backup list 201 of image files thus registered. Now, the contents included in the backup list 201 will be described. “DBOF” shown at the upper left is an identifier indicating that this file is a backup list. The numbers “0001”, “0002”, . . . shown at the leftmost column are sequence numbers for checking the number of image files or the like and are fixed values. “DCIM” is an identifier indicating that each image file (a still image file or a moving image file) is shot by a digital camera. “100TOSHI”, “101TOSHI”, or the like represents the folder name of a folder in which an image file is stored. In the present invention, the folder corresponds to the aforementioned album.

“MEH0001.jpg”, “MEH0010.mpg”, and the like each represent the file name of each image file. In the file name, the number such as “0001” represents the temporal ordering in which an image file is stored (shot) in each folder, “jpg” represents a still image file, and “mpg” represents a moving image file. For example, an image file represented by “100TOSHI/MEH0001.jpg” shown at the first line represents a still image file “MEH0001.jpg” which is the first one stored in a folder “100TOSHI”.

Image files are registered in the order selected by the user. In FIG. 8A, first, the file “MEH0001.jpg” which is the first one stored in the folder “100TOSHI” is registered, and then, the file “MEH0001.jpg” which is the first one stored in the folder “101TOSHI” is registered, after which the file “MEH0002.jpg” which is the second one in the folder “101TOSHI” is registered.

Referring back to the description of FIG. 6, as shown at B106, when “SET” on the backup list creation screen 22 is selected by the user, the CPU 20 displays a screen 23, such as the one shown in FIG. 9, on the liquid crystal monitor 111 and asks the user whether the image data is arranged in time-series order (B108).

When “YES” is selected on the screen 23 (“YES” at B108), the CPU 20 arranges, in the backup list 201, the file names of the image files in time-series order (in the order in which the images are shot by the camera 1). When “NO” is selected on the screen 23 (“NO” at B108), the CPU 20 does not rearrange the file names registered in the backup list 201.

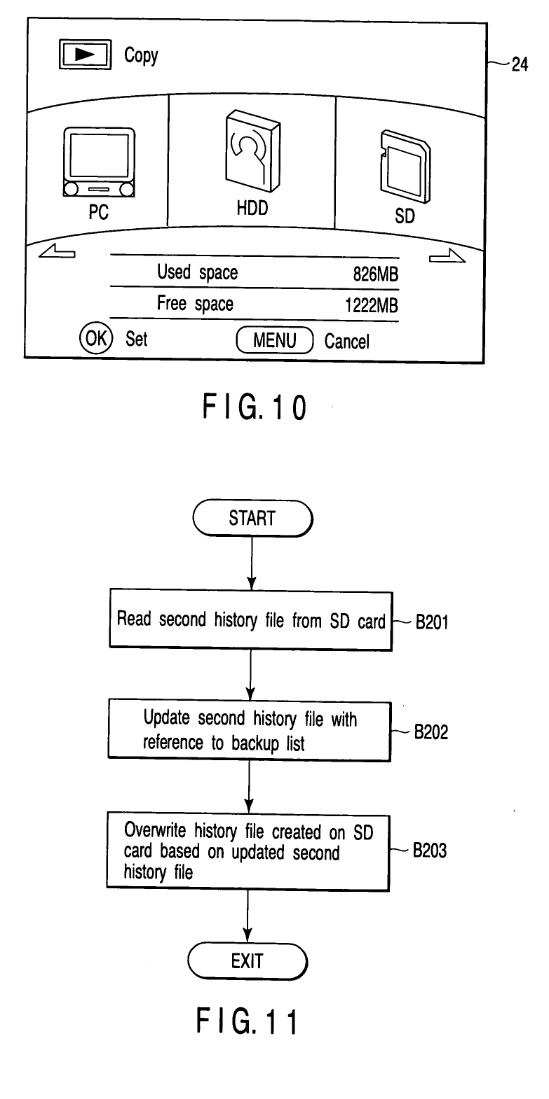

Then, the CPU 20 displays on the liquid crystal monitor 111 a screen 24, such as the one shown in FIG. 10, that allows the user to select a recording medium where the images are to be saved, and asks the user which one of the SD 32B, the HDD 32A, the PC, and the dedicated writer 200 is the destination to save the images (B110). When either the SD card 32B or the HDD 32A is selected (“YES” at B110), the CPU 20 allows image data corresponding to the file names registered in the backup list 201, to be saved on the specified destination to save. The CPU 20 then creates (updates for the next time) a history file 208 based on the backup list 201 (B112). The history file 208 shows the backup status of files. The history file 208 lists the file names of backed up image files and the name of a medium or a device where the image files are backed up, and is saved on the HDD 32A.

FIG. 8B is a diagram showing a history file (BUHY) 208 which is created when image files saved on the HDD 32A are backed up to the SD card 32B. All the file names registered in the backup list of FIG. 8A are copied to the history file 208, and each file name is tagged with an identifier [SD] of the destination to save. After this, whenever an image file is backed up, the CPU 20 updates the history file 208 with reference to the backup list. Specifically, the file name of a backed up image file and the identifier of the destination to save are added to the history file 208.

Such a history file is also created on the SD card 32B as a second history file. In this case, each file name listed in the history file created on the SD card 32B is tagged with an identifier [HDD]. Furthermore, each time an image is backed up to the SD card 32B, the CPU 20 updates the second history file created on the SD card 32B.

FIG. 11 is a flowchart showing an exemplary process of updating the second history file. Specifically, when an image is backed up (added) to the SD card 32B, the CPU 20 reads the second history file from the SD card as a database file 208 (B201) and updates the second history file with reference to the backup list (B202). The CPU 20 then overwrites the history file which is already created on the SD card based on the updated second history file (B203).

Accordingly, for a plurality of images recorded on the SD card 32B, it is possible to distinguish images directly stored on the SD card after shooting from images copied from the HDD 32A. Therefore, as will be described later, the operation of, for example, deleting the images on the SD card can be safely performed.

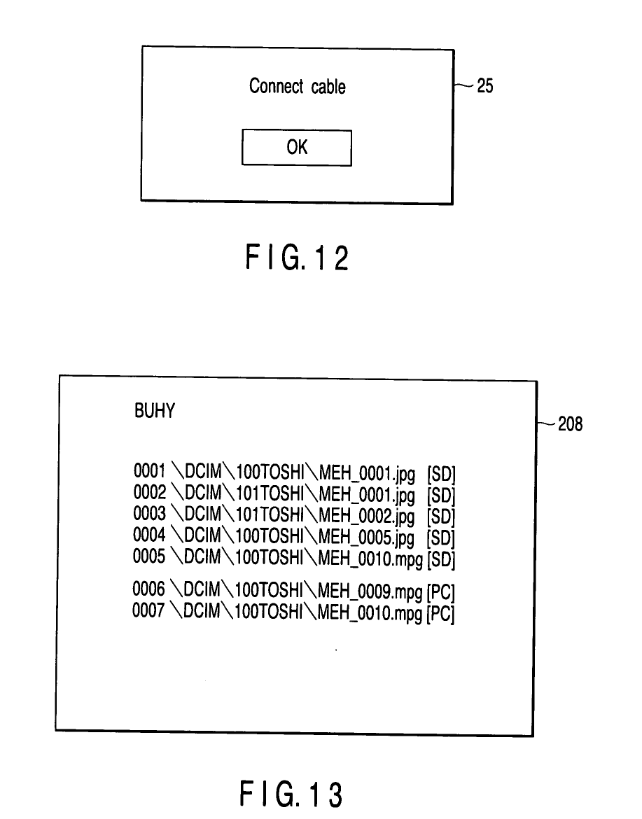

When the destination to back up the image data is either the PC 204 or the dedicated writer 200 (“NO” at B110), the CPU 20 displays on the liquid crystal monitor 111 a cable connection instruction screen 25, such as the one shown in FIG. 12, and instructs the user to connect the camera 1 to either the PC 204 or the dedicated writer 200 using a cable. In response to the instruction, the user connects the camera 1 to either the PC 204 or the dedicated writer 200 and selects the OK button on the cable connection instruction screen 25. In response to the selection, the image files listed in the backup list 201 are copied from the camera 1 to the dedicated writer 200 or to the general-purpose media 205 through the disk drive 207 of the PC 204.

When the copy of the image data is complete (“YES” at B114), the flow moves to B112, and as described above, the CPU 20 creates the history file 208 based on the backup list 201. In the case of the second or subsequent backup process (the case in which the history file 201 is already present in the camera 1), the CPU 20 updates the history file 208 based on the backup list 201. FIG. 13 is a diagram showing the history file 208 thus updated. This example shows the case in which two image files are backed up to the PC 204. In the example, there are shown in the first to fifth lines the file names of the images previously backed up to the SD card 32B, after which there are added in the sixth and seventh lines the file names of the two image files backed up to the PC 204. Each file name is tagged with an identifier [SD] or [PC] of the destination to back up.

Now, the processes shown by B113, B114, and B112 of FIG. 6 according to a second embodiment will be described. In the second embodiment, when image data is backed up to a PC 204 or a dedicated writer 200, a history file is created (updated) by the PC 204 or the dedicated writer 200. This process is performed by a backup processing unit 203 shown in FIG. 5.

As shown in FIG. 5, the dedicated writer 200 has the backup processing unit 203 as a hardware, and the PC has the backup processing unit 203 as an application software. The application software can be stored on an optical disk, such as a CD, or an HDD and is loaded into RAM (not shown) of the PC and executed.

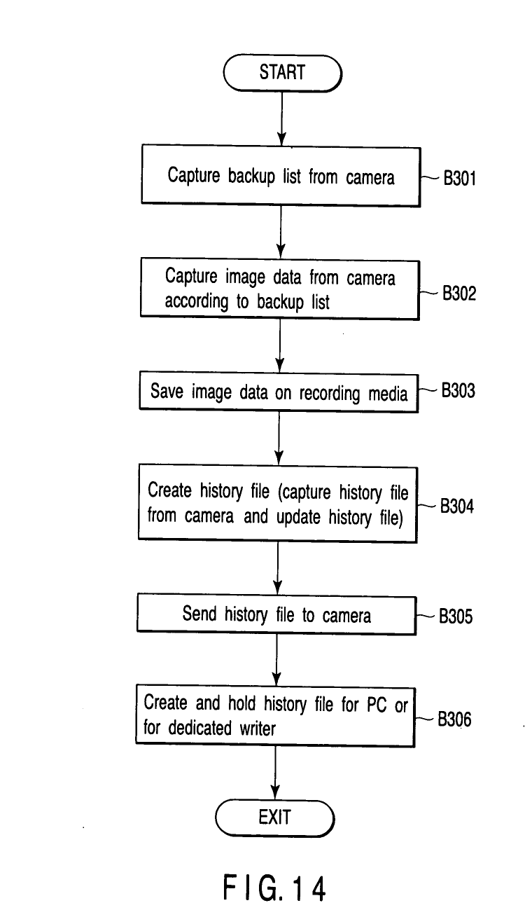

FIG. 14 is a flowchart showing the operation according to the second embodiment, which is performed instead of B113, B114, and B112 of FIG. 6.

When the destination to back up image data is the PC 204 or the dedicated writer 200 (“NO” at B110 of FIG. 6), the backup processing unit (hereinafter simply referred to as the “processing unit”) 203 captures, as shown at B301, a backup list 201 from a camera 1. The processing unit 203 captures image data from the camera 1 according to the backup list 201 (B302) and saves the image data on the recording media (B303).

The processing unit 203 creates a history file with reference to the backup list (B304). In the case of the second or subsequent backup process (the case in which a history file 208 is already present in the camera 1), the processing unit 203 captures the history file 201 from the camera 1 and updates the history file 208, as shown in FIG. 13, with reference to the backup list. As shown at B305, the processing unit 203 sends the created (updated) history file 208 to the camera 1 as a database file.

Then, as shown at B306, the processing unit 203 creates and holds a third history file for the PC 204 or for the dedicated writer 200, based on the backup list captured at B301 and according to the device to which the image data is backed up. In the third history file, the file name of the image data copied from the camera 1 is stored so as to be tagged with an identifier (not shown) indicating that the image data is copied from the camera 1.

When the camera 1 receives the created history file, the camera 1 holds the history file. When the camera 1 receives the updated history file, the camera 1 replaces the previous history file with the received history file. As such, each time image data is backed up, the history file of the camera 1 is updated.

Now, an embodiment using a backup status shown by the history file 208 will be described.

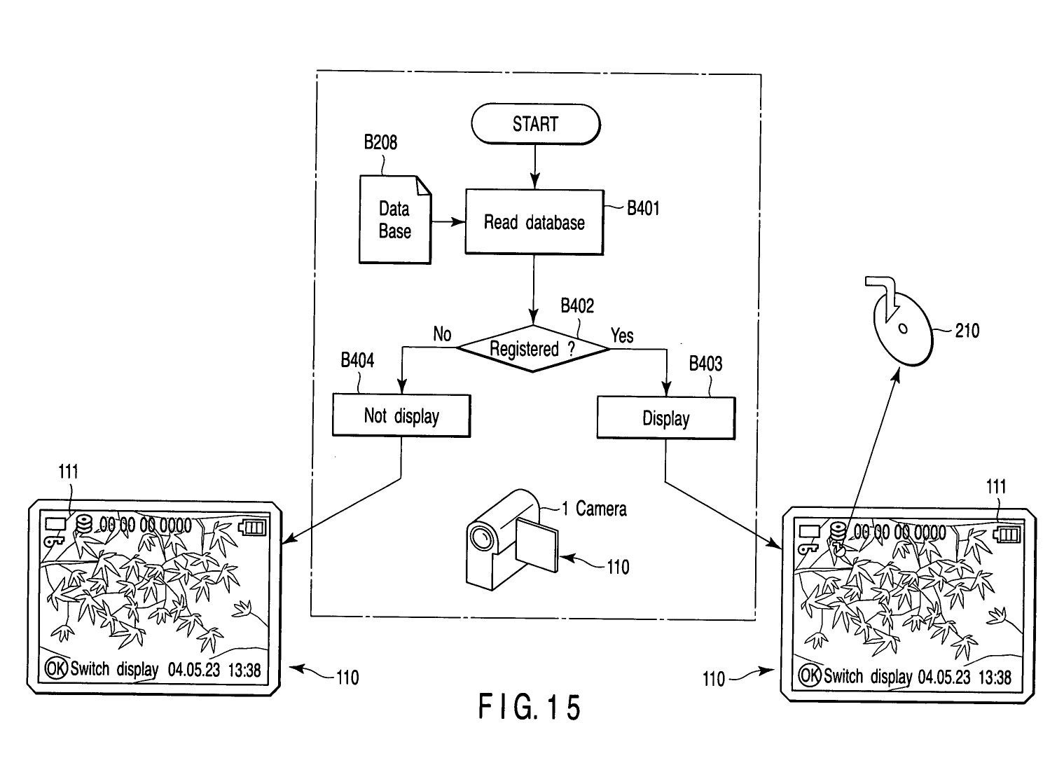

The camera 1, at normal playback, displays an icon 210 on the liquid crystal monitor 111 of the display unit 110 equipped to the camera 1 based on information included in the history file 208. FIG. 15 is a flowchart for explaining a backup status display function at image playback.

The CPU 20 displays on the liquid crystal monitor 111 an image selected and specified by the user and also reads the history file 208 from the HDD 32A (B401), and determines whether the selected image is registered in the history file 208 (B402). When the image being displayed is registered in the history file 208, the CPU 20 displays the icon 210 so as to be superimposed on the image (B403). When the image being displayed is not registered in the history file 208, the CPU 20 does not display the icon 210 (B404). This function is an effective function when, for example, an important image is backed up.

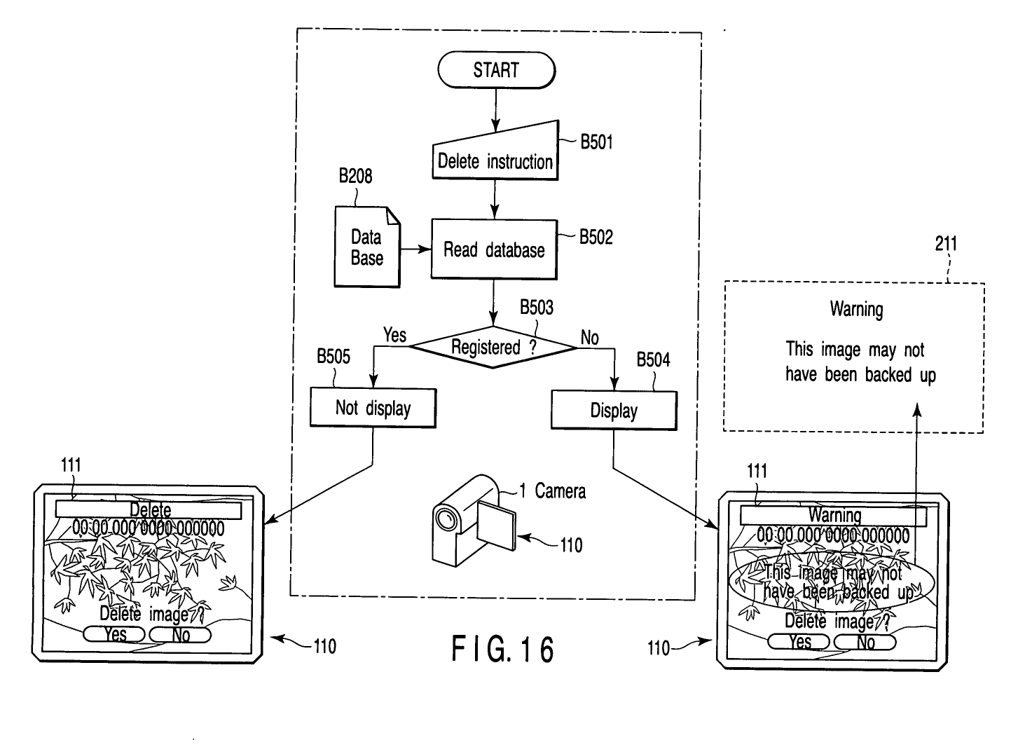

FIG. 16 is a diagram showing another embodiment using a backup status shown by a history file. When in the camera 1 an image delete function is performed, a warning 211 is displayed on the liquid crystal monitor 111 of the display unit 110 equipped to the camera 1 based on information included in the history file 208.

When an instruction to delete an image being displayed is issued (B501), the CPU 20 reads the history file 208 from the HDD 32A (B402) and determines whether the image to which the delete instruction is issued is registered in the history file 208 (B403). If the image is not registered in the history file 208 (if the image has not been backed up), the warning 211 is displayed (B504). If the image is registered in the history file 208, the warning 211 is not displayed (B505). By this function, an important image which has not been backed up is prevented from being deleted by mistake.

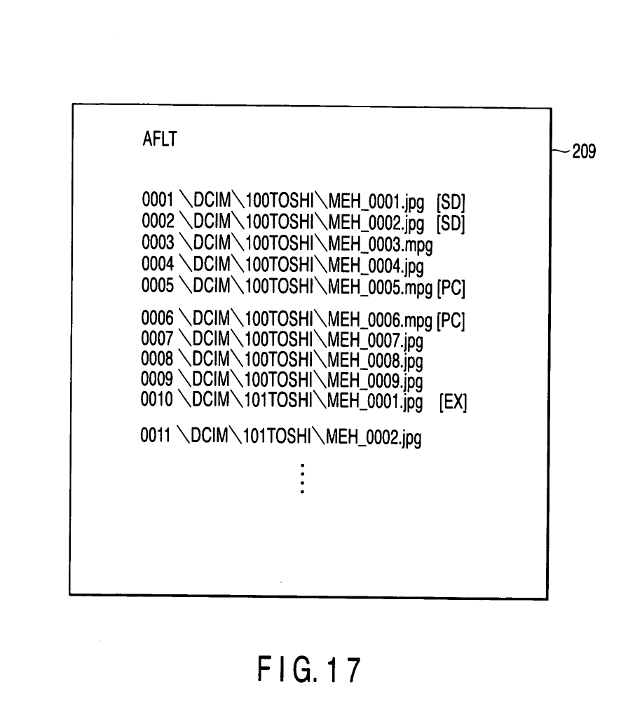

Although, in the above description, identification of backed up image files is made using the history file 208. However, identification of backed up image files can be made using a file-name list. The file-name list shows, for example, file information on all image files stored on the HDD 32A. FIG. 17 is a diagram showing a file-name list 209 on the HDD 32A, to which backup history information is appended.

The file-name list 209 is a listing including all file names of image files stored by shooting and image files which are backed up to another recording medium. [SD] is an identifier indicating that the file is backed up to the SD card 32B. [PC] is an identifier indicating that the file is backed up to the PC 204. [EX] is an identifier indicating that the file is backed up to the dedicated writer 200. A file that is not tagged with a backup identifier is a file directly stored on the HDD 32A after shooting by the camera 1.

As described above, in electronic camera devices according to the embodiments of the present invention, the backup state of image data is stored on the device and can be easily checked by the user, and thus, it is possible to prevent a misoperation such as deletion of data by mistake.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic camera device comprising:
a shooting unit which shoots an optical image and provides one of a still image and a moving image;
a storage unit which records the image obtained by the shooting unit on a first recording medium as an image file;
a selection unit to arbitrarily select an image from images stored on the first recording medium;
a copy unit which copies the image selected by the selection unit to a second recording medium; and
a history file creation unit which creates a list of the image copied by the copy unit as a history file and stores the history file on the first recording medium.

2. The electronic camera device according to claim 1, wherein the history file creation unit creates the history file so as to identify a copy destination of the image copied by the copy unit.

3. The electronic camera device according to claim 2, wherein the first recording medium is a hard disk drive equipped to the device, and the second recording medium is a memory card that can be removed from the device.

4. The electronic camera device according to claim 2, wherein the first recording medium is a memory card that can be removed from the device, and the second recording medium is a hard disk drive equipped to the device.

5. The electronic camera device according to claim 1, wherein when another image stored on the first recording medium is copied to the second recording medium by the copy unit, the history file creation unit updates the history file.

6. The electronic camera device according to claim 5, wherein when an image is copied by the copy unit to an external recording device connected to the electronic camera device, an update unit sends to the external recording device the history file already created and receives an updated history file from the external recording device.

7. The electronic camera device according to claim 1, wherein the history file creation unit stores on the second recording medium a second history file indicating that the image copied to the second recording medium is copied from the first recording medium.

8. The electronic camera device according to claim 7, wherein when another image stored on the first recording medium is copied to the second recording medium by the copy unit, the history file creation unit updates the second history file on the second recording medium.

9. The electronic camera device according to claim 1, further comprising:
a playback unit which plays back the image stored on the first recording medium;
a display unit which displays the image played back by the playback unit; and
a unit which determines, when the image stored on the first recording medium is displayed on the display unit, whether the image being displayed has been already copied by the copy unit with reference to the history file and displays, when the image has been already copied, on the display unit an icon indicating that the image has been already copied, together with the image being displayed.

10. The electronic camera device according to claim 1, further comprising:
a playback unit which plays back the image stored on the first recording medium;
a display unit which displays the image played back by the playback unit;
a unit which selects a candidate for deletion from the images stored on the first recording medium and displays the selected candidate on the display unit;
a unit which determines, with reference to the history file, whether an image being displayed as the candidate for deletion has been already copied by the copy unit; and
a unit that displays a warning when the candidate for deletion has not been already copied and an instruction to delete the candidate for deletion is issued.

11. A method of creating a history file in an electronic camera device, the method comprising:
storing an image obtained by shooting an optical image on a first recording medium as an image file;
arbitrarily selecting an image from images stored on the first recording medium;
copying the selected image to a second recording medium; and
creating a list of the copied image as a history file showing a copy state and storing the history file on the first recording medium.
